(19) United States
(12) Patent Application Publication
(10) Pub. No.: US 2025/0264759 A1
(43) Pub. Date: Aug. 21, 2025

(54) DECORATIVE SHEET AND DISPLAY DEVICE INCLUDING DECORATIVE SHEET

(71) Applicant: Panasonic Holdings Corporation, Osaka (JP)

(72) Inventors: Yuma SASAGAWA, Osaka (JP); Kazuhiko KANEUCHI, Osaka (JP); Takanori KOSHIMIZU, Osaka (JP); Masato KURAHASHI, Kyoto (JP)

(21) Appl. No.: 19/056,212

(22) Filed: Feb. 18, 2025

(30) Foreign Application Priority Data
Feb. 19, 2024 (JP) 2024-022958

(51) Int. Cl. G02F 1/13357

(52) U.S. Cl. CPC G02F 1/133606

(57) ABSTRACT

The decorative sheet according to the present disclosure comprises a first pattern layer and a second pattern layer each including an interference pigment that reflects light incident and develops color with reflected interference light in a first wavelength region. The first pattern layer including a first area with a first light intensity and a second area with a second light intensity. The second pattern layer including a third area with a third light intensity and a fourth area with a second light intensity. The first region and the third region are overlapped each other, and the second region and the fourth region are overlapped each other. The first light intensity is greater than the second light intensity, and the third light intensity is less than the fourth light intensity.

### CROSS-REFERENCE TO RELATED APPLICATIONS

This application claims priority of Japanese Patent Application No. 2024-022958 filed on Feb. 19, 2024, the content of which is incorporated herein by reference.

### TECHNICAL FIELD

The present disclosure relates to a decorative sheet. In particular, the present disclosure relates to a decorative sheet capable of being backlighted and a display device including the decorative sheet.

### BACKGROUND

A decorative sheet capable of being backlighted has conventionally been used for an electrical appliance product, an automobile part, or the like. When the back surface of this type of decorative sheet is illuminated with a light source, light passes through the whole or a part of the decorative sheet and is visually recognized from the front surface side of the decorative sheet. On the other hand, in a state where the back surface is not illuminated with a light source, a decoration pattern provided on the front surface of the decorative sheet, for example, the color tone of natural wood, is visually recognized, and the structure such as the light source on the back surface side is not visually recognized from the front surface side through the material.

One of this type of decorative sheet, for example, a decorative sheet is described in Japanese Patent Publication No. 2021-178341 A. The decorative sheet described in the above patent document includes a pattern layer containing an interference pigment having a property of developing color by interference of a part of reflected light of the light incident on the surface.

In the decorative sheet described in the above patent document, light transmission properties may vary depending on different areas on the pattern layer constituted by the interference pigment. As a result, when viewing from the front surface side of the decorative sheet, the visibility of the light incident on the back surface and transmitted through the decorative sheet can be impaired. Thus, problems including, for example, patterns appearing overlapped on the optical display, or un-uniform displaying may occur.

### SUMMARY

The present disclosure is aimed to solve the above-described conventional problem, and an object of the present disclosure is to provide a decorative sheet that improves visibility of displaying with transmitted light.

According to one aspect of the present disclosure, a decorative sheet including a number of layers between a front surface and a back surface is provided. The decorative sheet includes a first pattern layer and a second pattern layer. The first pattern layer includes an interference pigment that reflects light incident and develops color with reflected interference light in a first wavelength, and includes a first area that develops color with the reflected interference light of a first light intensity and a second area that develops color with the reflected interference light of a second light intensity. The second pattern layer includes an interference pigment that reflects light incident and develops color with reflected interference light in the first wavelength region, and includes a third area that develops color with the reflected interference light of a third light intensity and a fourth area that develops color with the reflected interference light of a fourth light intensity. In a thickness direction of the decorative sheet, the first region and the third region are disposed to overlap each other, and the second region and the fourth region are disposed to overlap each other. The first light intensity is greater than the second light intensity, and the third light intensity is less than the fourth light intensity.

According to another aspect of the present disclosure, a decorative sheet including a number of layers between a front surface and a back surface is provided. The decorative sheet includes a first pattern layer and a second pattern layer. The first pattern layer includes an interference pigment that reflects light incident and develops color with reflected interference light, and includes two or more first areas that each develop color with the reflected interference light in a wavelength region different from each other. The second pattern layer includes an interference pigment that reflects light incident and develops color with reflected interference light, and includes two or more second areas that are disposed to overlap each of the first areas in a thickness direction of the decorative sheet. At least a part of the first areas and the second areas overlapping each other include interference pigments that develop complementary colors with each other.

In the present specification, the term “sheet” is intended to refer to an object with sufficiently small thickness, meaning an object whose thickness is significantly smaller than its planar dimensions. A “sheet” may include, for example, film, cover, layer, or panel, but it is not limited to these. The material or intended use of such objects is not taken into consideration.

Some aspects of the present disclosure provide decorative sheets that improve visibility of displaying with transmitted light, and other aspects of the present disclosure provide display devices including the decorative sheets.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1A is a conceptual sectional view of a display device including a decorative sheet according to an embodiment of the present disclosure without light irradiation from the back surface;

FIG. 1B is an example of the decoration pattern appearing on the front surface side of the display device in FIG. 1A;

FIG. 2A is a conceptual sectional view of the display device including the decorative sheet according to an embodiment of the present disclosure with light irradiation from the back surface;

FIG. 2B is an example of the displaying on the front surface side of the display device in FIG. 2A;

FIG. 3 is a conceptual diagram for describing reflection and transmission of light at an interference pigment particle;

FIG. 4 is a conceptual sectional view for describing the influence of the transmission properties of the interference pigment;

FIG. 5 is a conceptual sectional view of a display device according to a first embodiment of the present disclosure, illustrating a decorative sheet included and transmission properties thereof in a first configuration example;

FIG. 6 is a conceptual sectional view of a display device according to the first embodiment of the present disclosure, illustrating a decorative sheet included and transmission properties thereof in a second configuration example;

FIG. 7 is a conceptual sectional view of a display device according to the first embodiment of the present disclosure, illustrating a decorative sheet in a third configuration example;

FIG. 8 is a conceptual sectional view of a display device according to the first embodiment of the present disclosure, illustrating a decorative sheet in a fourth configuration example;

FIG. 9 is a conceptual sectional view for describing the influence of the transmission properties of the interference pigment;

FIG. 10 is a conceptual sectional view illustrating a display device according to a second embodiment of the present disclosure;

FIG. 11 is a conceptual sectional view illustrating a configuration of a pattern layer of a decorative sheet according to the second embodiment; and

FIG. 12 is a conceptual sectional view of the display device according to the second embodiment of the present disclosure, illustrating a decorative sheet included and the transmission properties thereof.

### DETAILED DESCRIPTION

In a first embodiment, a decorative sheet according to one aspect of the present disclosure including a number of layers between a front surface and a back surface is provided. The decorative sheet includes a first pattern layer and a second pattern layer. The first pattern layer includes an interference pigment that reflects light incident and develops color with reflected interference light in a first wavelength region, and includes a first area that develops color with the reflected interference light of a first light intensity and a second area that develops color with the reflected interference light of a second light intensity. The second pattern layer includes an interference pigment that reflects light incident and develops color with reflected interference light in the first wavelength region, and includes a third area that develops color with the reflected interference light of a third light intensity and a fourth area that develops color with the reflected interference light of a fourth light intensity. In a thickness direction of the decorative sheet, the first region and the third region are disposed to overlap each other, and the second region and the fourth region are disposed to overlap each other. The first light intensity is greater than the second light intensity, and the third light intensity is less than the fourth light intensity.

In addition, a decorative sheet according to another aspect in the first embodiment of the present disclosure is provided, wherein a relative standard deviation value for a total value of the first light intensity and the third light intensity, and a total value of the second light intensity and the fourth light intensity is less than 10%.

In addition, a decorative sheet according to another aspect in the first embodiment of the present disclosure is provided. The decorative sheet further includes a light shielding layer disposed between the first pattern layer and the second pattern layer, wherein the light shielding layer has a transmittance of less than 50% for incident light in a visible region.

In addition, a decorative sheet according to another aspect in the first embodiment of the present disclosure is provided. The decorative sheet further includes a chromaticity compensation layer disposed between the light shielding layer and the back surface of the decorative sheet, wherein the chromaticity compensation layer has a lower transmittance for light in a wavelength region different from the first wavelength region than that for light in the first wavelength region.

In addition, a decorative sheet according to another aspect in the first embodiment of the present disclosure is provided, wherein the light shielding layer and the chromaticity compensation layer are integrally formed.

In addition, a decorative sheet according to another aspect in the first embodiment of the present disclosure is provided, wherein the first pattern layer includes two or more layers each including an interference pigment that reflects light incident and develops color with reflected interference light in a wavelength region different from each other, the second pattern layer includes two or more layers each corresponding to one of the plurality of layers of the first pattern layer, the two or more layers of the second pattern layer each including an interference pigment that reflects light incident and develops color with reflected interference light in a substantially same wavelength region as the wavelength region of the reflected interference light with which the interference pigment of a corresponding one of the two or more layers of the first pattern layers develops color, and each layer of the two or more layers of the second pattern layer includes areas disposed to overlap each of the areas included in the corresponding one of the two or more layers of the first pattern layer as viewed in the thickness direction.

A display device according to another aspect in the first embodiment of the present disclosure is provided. The display device comprises a decorative sheet described above, and an optical device that emits light. The optical device is disposed to face the back surface of the decorative sheet.

In a second embodiment, a decorative sheet according to another aspect of the present disclosure including a number of layers between a front surface and a back surface is provided. The decorative sheet includes a first pattern layer and a second pattern layer. The first pattern layer includes an interference pigment that reflects light incident and develops color with reflected interference light, and includes two or more first areas that each develop color with the reflected interference light in a wavelength region different from each other. The second pattern layer includes an interference pigment that reflects light incident and develops color with reflected interference light, and includes two or more second areas that are disposed to overlap each of the first areas in a thickness direction of the decorative sheet. At least a part of the first areas and the second areas overlapping each other include interference pigments that develop complementary colors with each other.

In addition, a decorative sheet according to another aspect in the second embodiment of the present disclosure is provided. The decorative sheet further includes a light shielding layer disposed between the first pattern layer and the second pattern layer, wherein the light shielding layer has a transmittance of less than 50% for incident light in a visible region.

Further, a display device according to another aspect in the second embodiment of the present disclosure is provided. The display device includes a decorative sheet described above, and an optical device that emits light. The optical device is disposed to face the back surface of the decorative sheet.

With the decorative sheets and the display devices according to the present disclosure, the visibility of displaying with transmitted light can be improved.

By appropriately combining any embodiments among the various embodiments described above, the effects of the respective embodiments can be achieved.

Hereinafter, embodiments will be described in detail with reference to the drawings. Unnecessarily detailed description may be omitted. For example, a detailed description of a well-known matter and a repeated description of substantially the same configuration may be omitted. This is to avoid unnecessary redundancy of the following description and to facilitate understanding of the skilled person.

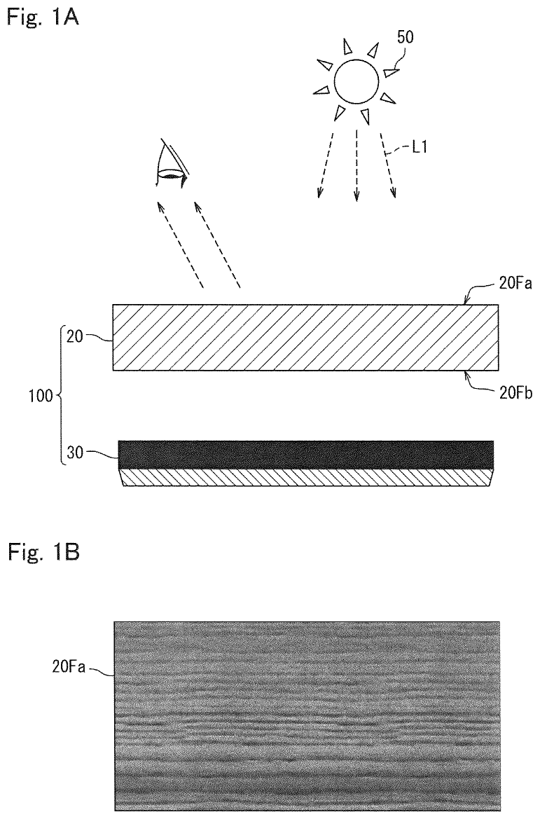

A decorative sheet and a display device according to the embodiments of the present disclosure will be described with reference to FIGS. 1A to 12. The accompanying drawings and the following description are provided for the skilled person to fully understand the present disclosure, and they are not intended to limit the subject matter described in the claims. In each drawing, each element is exaggerated to facilitate the description. Substantially the same members in the drawings are denoted by the same reference numerals.

### Display Device Including Decorative Sheet

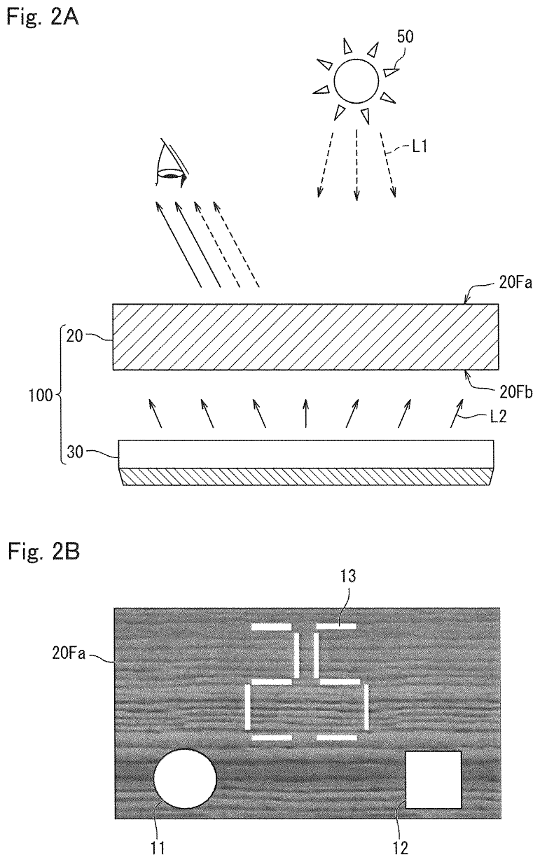

A configuration of a display device including a decorative sheet according to an embodiment of the present disclosure will be described with reference to FIGS. 1A, 1B and FIGS. 2A, 2B. FIG. 1A is a conceptual sectional view of a display device 100 including a decorative sheet according to an embodiment of the present disclosure without light irradiation from the back surface. FIG. 1B is an example of the decoration pattern appearing on the front surface side of the display device in FIG. 1A. FIG. 2A is a conceptual sectional view of the display device 100 including the decorative sheet according to an embodiment of the present disclosure with light irradiation from the back surface. FIG. 2B is an example of the displaying on the front surface side of the display device in FIG. 2A.

As shown by FIGS. 1A and 2A, the display device 100 according to an embodiment of the present disclosure includes a decorative sheet 20 and an optical device 30. The optical device 30 is disposed facing a back surface 20Fb of the decorative sheet 20 and can emit light to irradiate the back surface 20Fb of the decorative sheet 20.

In FIG. 1A, when the optical device 30 is turned off, a front surface 20Fa of the decorative sheet 20 is irradiated with light L1 that may be, for example, natural light from an external light source 50. At this time, the front surface 20Fa exhibits only a decoration pattern, for example, the woodgrain pattern shown by FIG. 1B. The decoration pattern exhibited on the front surface 20Fa when the optical device 30 is turned off may be a pattern designed on a pattern layer of the decorative sheet 20. The configuration of the decorative sheet 20 will be described in detail later.

In FIG. 2A, when the optical device 30 is turned on, the front surface 20Fa of the decorative sheet 20 is irradiated with the light L1 from the external light source 50, and at the same time, the decorative sheet 20 is irradiated with the light L2 from the optical device 30. The light L2 enters the back surface 20Fb of the decorative sheet 20, and a part of the light L2 is transmitted through the decorative sheet 20. At this time, illumination lights 11 and 12 and a display mark 13 are displayed in the woodgrain pattern on the front surface 20Fa as shown by FIG. 2B. The woodgrain pattern shown by FIG. 1B or the illumination lights and the display mark shown by FIG. 2B are just examples for describing a pattern or displaying of the display device 100, and the present disclosure is not limited to these.

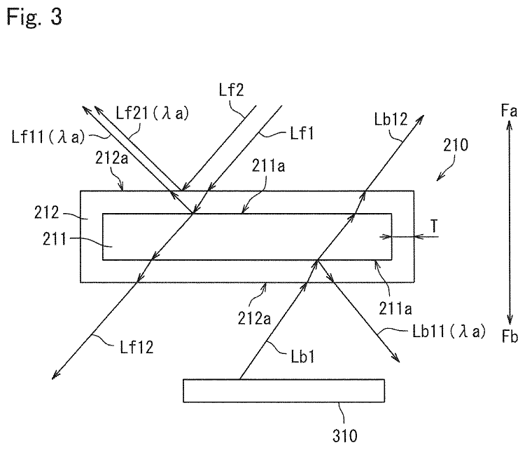

The pattern exhibited on the front surface 20Fa of the decorative sheet 20 can be formed by a pattern layer containing an interference pigment. The properties of the interference pigment will be described below with reference to FIG. 3. FIG. 3 is a conceptual diagram for describing reflection and transmission of light at an interference pigment particle 210.

The interference pigment is a pigment that develops color via optical physical phenomena such as optical reflection and interference. The interference pigment particles constituting such an interference pigment can have a core-shell structure. Interference pigment particles can be constructed by coating a core portion having a relatively low refractive index with a metal oxide having a relatively high refractive index. The base material serving as the core portion is formed of, for example, plate-shaped mica, and the periphery of the base material is covered by a metal oxide, such as titanium dioxide (TiO₂) or iron oxide (Fe₂O₃).

As conceptually illustrated in FIG. 3, the interference pigment particle 210 include, for example, a core portion 211 and a shell portion 212 covering the core portion 211. Both the core portion 211 and the shell portion 212 transmit light in the visible region. The core portion 211 and the shell portion 212 are made of materials having different refractive indexes, and for example, the refractive index of the core portion 211 is smaller than the refractive index of the shell portion 212.

As shown in the figure, when incident lights Lf1 and Lf2 from a front surface side Fa are obliquely incident on the interference pigment particle 210, on a surface 212a of the shell portion 212, a part of the incident light Lf1 travels into the shell portion 212 and is reflected by a surface 211a of the core portion 211 to become reflected light Lf11. A part of the incident light Lf2 is reflected by the surface 212a of the shell portion 212 to become reflected light Lf21. When the reflected light Lf11 and the reflected light Lf21 interfere with each other, and reflected light having a wavelength λa in the reflected lights Lf11 and Lf21 satisfies an interference condition on which the light is mutually intensified, the reflected interference light having the wavelength λa is visually recognized strongly. At this time, the interference pigment particles 210 can develop color with the reflected interference light having the wavelength λa. Here, the “reflected interference light” of the interference pigment particles is light satisfying the interference condition on which the light is mutually intensified within the lights reflected by the interference pigment particles. The interference pigment develops a “reflected color” which is a color in which the reflected interference light is visually recognized.

On the other hand, the other part of the incident light Lf1 transmitted through the surface 211a of the core portion 211 travels into the core portion 211, and a part thereof further transmits through the shell portion 212 on a back surface side Fb to become the transmitted light Lf12. The color in which the transmitted light Lf12 is visually recognized is a “transmitted color”, and the “reflected color” of the reflected interference light of the interference pigment particles and the “transmitted color” of the transmitted light are complementary colors with each other. Here, the “complementary colors” or “light having a complementary color relationship” refers to a pair of colors at diametrical positions opposite to each other in a color wheel. In this manner, the transmitted light having a complementary color relationship with the color of the reflected interference light of the interference pigment particles is transmitted through the interference pigment particles, and the combination of the reflected interference light and the transmitted light results to a spectrum of substantially white light.

Similarly, as shown in the figure, when incident light Lb1 from a light source element 310 on the back surface side Fb is incident on the interference pigment particles 210, the reflected interference light having the wavelength λa is reflected by the back surface side Fb, and the transmitted light Lb12 is emitted from the interference pigment particles 210 on the front surface side Fa and visually recognized. At this time, the transmitted light Lb 12 emitted on the front surface side Fa is constituted by light having a complementary color relationship with the reflected interference light of the interference pigment particles, and it contributes to displaying for the light source element 310 on the front surface side Fa.

The wavelength λa of the reflected interference light can be changed by adjusting a thickness T of the shell portion 212 of the interference pigment particles, and interference pigment particles having different reflected colors are obtained. By mixing the interference pigment particles having different reflected colors, an interference pigment that reflects light incident and develops color with reflected interference light in a predetermined wavelength region can be formed.

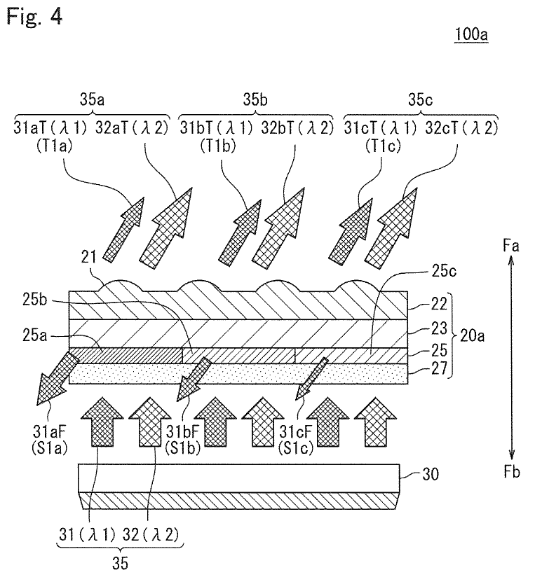

The interference pigment can be used to form the pattern layer that forms a pattern or displaying exhibited on the front surface of the display device 100 shown in FIGS. 1B and 2B. However, the visibility of displaying of the display device 100 may be affected by the transmission properties of the interference pigment. This will be described below with reference to FIG. 4. FIG. 4 is a conceptual sectional view for describing the influence of the transmission properties of the interference pigment.

FIG. 4 illustrates a display device 100a including the optical device 30 and a decorative sheet 20a. The decorative thin material 20a includes a pattern layer 25 containing an interference pigment. The decorative sheet 20a includes a hard coat layer 22, a base layer 23, the pattern layer 25, and a light shielding layer 27 in the thickness direction from the front surface side Fa to the back surface side Fb. The hard coat layer 22, the base layer 23, and the light shielding layer 27 will be described in detail later.

The pattern layer 25 of the decorative sheet 20a in FIG. 4 contains, for example, an interference pigment that reflects light incident and develops color with reflected interference light in the wavelength region λ1. The pattern layer 25 includes areas 25a, 25b, and 25c, and the areas 25a, 25b, and 25c are configured to contain interference pigments that develop colors with reflected interference lights having different light intensities but substantially in the same wavelength region λ1. The present disclosure is not limited to the configuration of the areas in which colors are developed with reflected interference lights having different light intensities but substantially in the same wavelength region λ1. For example, such areas can be formed by containing interference pigment particles having similar shell portion thicknesses and adjusting the contents of the interference pigment particles, for example, the wt % of the interference pigments. Alternatively, for example, such areas can be formed by changing the types of the interference pigment particles to be contained.

The optical device 30 at the back surface side Fb emits light 35, which enter the decorative sheet 20a including the pattern layer 25 configured as described above. The incident light 35 includes incident light 31, 32, in which incident light 31 is in the wavelength region λ1, and incident light 32 is in a wavelength region λ2 different from the wavelength region λ1. The incident light 35 is incident on the back surface of the decorative sheet 20a with substantially uniform luminance. Within the incident light 35, the incident light 31 in the wavelength region λ1 satisfies the interference condition on which the light is mutually intensified, and a part thereof is reflected as reflected interference lights 31aF, 31bF, and 31cF at the areas 25a, 25b, and 25c of the pattern layer 25. Since the areas 25a, 25b, and 25c have properties of developing color with different light intensities, the light intensities of the reflected interference lights 31aF, 31bF, and 31cF are different. For example, as indicated by the thicknesses of the arrows shown in FIG. 4, the light intensities of the reflected interference lights 31aF, 31bF, and 31cF may satisfy S1a>S1b>S1c. On the other hand, within the incident light 35, the incident light 32 in the wavelength region λ2 does not satisfy the interference condition on which the light is mutually intensified, and is transmitted through the areas 25a, 25b, and 25c of the pattern layer 25 with substantially uniform light intensity.

On the front surface side Fa, transmitted lights 35a, 35b, and 35c including lights in the complementary colors with the reflected interference lights 31aF, 31bF, and 31cF are emitted from the areas 25a, 25b, and 25c, respectively. The transmitted lights 35a, 35b, and 35c include transmitted lights 31aT, 31bT, and 31cT in the wavelength region λ1 and transmitted lights 32aT, 32bT, and 32cT in the wavelength region λ2. The transmitted lights 32aT, 32bT, and 32cT in the wavelength region λ2 have substantially uniform light intensity, but the light intensities of the transmitted lights 31aT, 31bT, and 31cT in the wavelength region λ1 satisfy T1a<T1b<T1c. Thus, on the front surface side Fa, the transmitted lights 35a, 35b, and 35c from the areas 25a, 25b, and 25c are emitted with non-uniform luminance.

Further, since the incident light 31 in the wavelength region λ1 satisfies the interference condition on which the light is mutually intensified, and a part of the incident light 31 is reflected as the reflected interference light. Then the transmitted lights 31aT, 31bT, and 31cT have a lower light intensity than the transmitted lights 32aT, 32bT, and 32cT in the wavelength region λ2 that does not satisfy the interference condition. Thus, for the transmitted lights 35a, 35b, and 35c on the front surface side Fa, the light component in the wavelength region λ1 is attenuated, and chromaticity shifts occur in the transmitted lights 35a, 35b, and 35c. Here, the chromaticity is a color property ignoring brightness, and is a numerical representation of the color, hue, and saturation of a light excluding lightness.

In this manner, the light incident on the back surface of the decorative sheet 20a including the pattern layer 25 including the areas that develop color with reflected interference lights of different light intensities but substantially in the same wavelength region λ1, is transmitted through the decorative sheet 20a and emitted with non-uniform luminance. In addition, in the transmitted light, light components of the wavelength region λ1 is attenuated, and thus chromaticity shifts occur. These non-uniform luminance and chromaticity shifts may impair the visibility of displaying.

In the present specification, “substantially equal” or “substantially the same” is not intended to merely indicate a completely same value, but also in consideration of actual tolerance in processing. For example, when “substantially equal” or “substantially the same” is mentioned, an error of about ±10% may be included, and preferably, an error of about ±5% may be included.

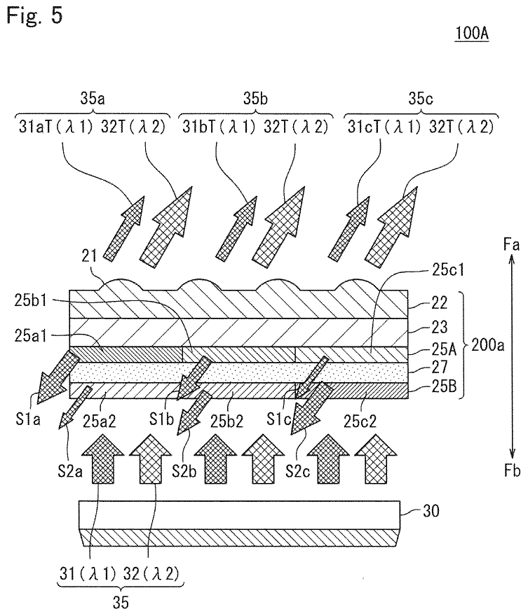

The decorative sheet according to a first embodiment of the present disclosure can improve the above problem in the decorative sheet 20a and improve the visibility of displaying with transmitted light. Hereinafter, the configuration of the decorative sheet according to the first embodiment will be described with reference to FIGS. 5 to 8. In FIGS. 5 to 8, substantially the same components as that shown in FIG. 4 are denoted by the same reference numerals, and associated detailed description thereof will be omitted.

### First Embodiment

### Configuration of Display Device and First Configuration Example of a Decorative Sheet

FIG. 5 is a conceptual sectional view of a display device according to a first embodiment of the present disclosure, illustrating a decorative sheet 200a included and transmission properties thereof in a first configuration example. The display device 100A shown in FIG. 5 includes the decorative sheet 200a and an optical device 30 emitting light, which is disposed on a back surface side Fb of the decorative sheet 200a. Similarly, to the display device 100 shown in FIG. 1, the display device 100A exhibits a pattern on a front surface of the decorative sheet 200a when the optical device 30 is turned off, and displaying of the optical device 30 appears on the front surface of the decorative sheet 200a when the optical device 30 is turned on.

The decorative sheet 200a includes a hard coat layer 22, a base layer 23, a first pattern layer 25A, a light shielding layer 27, and a second pattern layer 25B in the thickness direction from the front surface side Fa to the back surface side Fb. In the present embodiment, the second pattern layer 25B constitutes the back surface of the decorative sheet 200a, and the optical device 30 is disposed to face the second pattern layer 25B.

The hard coat layer 22 is made of a material having a protective function and having transparency for incident lights from both the front surface side Fa and the back surface side Fb. The hard coat layer 22 can be made of, for example, a transparent resin having high hardness, and can include, for example, a tactile feel imparting configuration according to the pattern design shown by the decorative sheet 200a. As shown in the drawings, for example, a textured pattern 21 such as fine irregularities representing a wood pattern or the like can be formed on the surface of the hard coat layer 22.

The base layer 23 is made of a material having transparency to incident lights from both the front surface side Fa and the back surface side Fb, and may have a flat plate shape or a three-dimensional shape. The base layer 23 can be formed using a material having light transparency such as polycarbonate resin, polyethylene terephthalate resin, or acrylic resin. The base layer 23 provides support for the pattern layers 25A and 25B and the light shielding layer 27, and can provide the necessary strength for the entire decorative sheet 200a.

The first pattern layer 25A includes an interference pigment that reflects light incident and develops color with reflected interference light in a predetermined wavelength region, and can form a pattern, for example, a woodgrain pattern and exhibit the pattern on the surface. In the present embodiment, the first pattern layer 25A includes first areas 25a1, 25b1, and 25c1 that are a plurality of color development areas. The first areas 25a1, 25b1, and 25c1 are configured to include interference pigments that develop color with reflected interference lights of different light intensities S1a, S1b, and S1c but substantially in the same wavelength region λ1.

The color development with the reflected interference light having different light intensities can be expressed by the density of the visually recognized color. An area that develops color with reflected interference light having a relatively strong light intensity is visually recognized as a relatively dark color, and an area that develops color with reflected interference light having a relatively weak light intensity is visually recognized as a relatively light color. In the present embodiment, the first pattern layer 25A is configured to develop color with reflected interference lights with different light intensities but substantially in the same wavelength region λ1, and is visually recognized to have areas of substantially the same color but with different color densities.

The second pattern layer 25B includes interference pigments that develop color with reflected interference light substantially in the same wavelength region as that for the first pattern layer 25A. Further, the second pattern layer 25B includes second areas 25a2, 25b2, and 25c2 that are a plurality of color development areas that develop color with different light intensities S2a, S2b, and S2c. Each of the second areas 25a2, 25b2, and 25c2 of the second pattern layer 25B is disposed to overlap the corresponding one of the first areas 25a1, 25b1, and 25c1 of the first pattern layer 25A when viewed from the thickness directions (directions indicated by the illustrated arrows) of the decorative sheet. Thus, when the optical device 30 is turned on, a part of the incident light 35 incident from the back surface side Fb can be transmitted through each overlapping second area and first area on the second pattern layer 25B and the first pattern layer 25A and output on the front surface side Fa.

The present disclosure is not limited to the configuration of the plurality of color development areas or the number of the areas on the first pattern layer 25A and the second pattern layer 25B. These color development areas may be configured, for example, by adjusting the content of the interference pigment particles, for example, the wt % of the interference pigment, or may be configured by including different types of interference pigment particles. The first pattern layer 25A and the second pattern layer 25B may be configured to include any number of two or more color development areas, and each color development area can have any shape and/or dimension. The color development areas in the same pattern layer can be freely defined but not overlapping with each other, and each pattern layer can be configured with any thickness according to intended uses.

In the measurement of the light intensity of the reflected interference light in each of the color development areas on the first pattern layer 25A and the second pattern layer 25B, for example, inputting the reflected interference light to a light receiving element disposed at a predetermined position at the emission direction of the reflected interference light, then the amount of light received by the light receiving element can be measured by a photodetector. The light receiving surface of the light receiving element can be disposed in a perpendicular direction to the reflected interference light. As the photodetector, for example, a sensing device such as a photodiode using the photoelectric effect can be used, and for example, the light intensity of the received reflected interference light can be output as an electric signal. The light intensity of the reflected interference light of each color development area can be an average value of a plurality of light intensity values measured for the light beams of the reflected interference light of the same.

The light shielding layer 27 can be used to shield a part of light incident on the decorative sheet 200a. In the present embodiment, the light shielding layer 27 has a transmittance of less than 50% for visible incident light on the decorative sheet 200a. The light shielding layer 27 can be configured to have substantially uniform transmittance over the spectrum of visible incident light on the decorative sheet 200a. With this configuration, the light shielding layer 27 can transmit a part of visible incident light without introducing chromaticity shifts. Since the light shielding layer 27 has a transmittance of less than 50% for visible light, it is possible to conceal the components disposed on the back surface side of the light shielding layer 27 such that the components are not visually recognized from the front surface side Fa. In the present embodiment, the light shielding layer 27 is disposed between the first pattern layer 25A and the second pattern layer 25B, and the light shielding layer 27 conceals both second pattern layer 25B and the optical device 30 such that they are not visually recognized from the front surface side Fa.

The decorative sheet 200a may be produced by stacking each constituent layer with an adhesive layer having light transparency in the visible region interposed therebetween, or may be produced through lamination printing of each constituent layer using a printing method such as screen printing or gravure printing.

### Configuration of Overlapped Color Development Areas on First Pattern Layer and Second Pattern Layer

In the present embodiment, in general, the first pattern layer of the decorative sheet may include a plurality of color development areas developing color with reflected interference light of different first light intensities, and the second pattern layer may include a plurality of color development areas developing color with reflected interference light of different second light intensities. When the first light intensities include a light intensity S11 and a light intensity S12, and the second light intensities include a light intensity S21 and a light intensity S22, the first light intensities S11 and S12 and the second light intensities S21 and S22 can be configured to satisfy the condition (1) of S11>S12 and S21<S22.

Further, in the present embodiment, in general, the first light intensities S11, S12 of the first pattern layer and the second light intensities S21, S22 of the second pattern layer can be configured to satisfy the condition (2) that the relative standard deviation (RSD) value for the total value of the light intensity S11 and S21, and the total value of the light intensity S12 and S22 is less than 10%. Here, the total value of the light intensity S11 and S21, and the total value of the light intensity S12 and S22 indicates the total value of the light intensities at an overlapping color development area pair, respectively. Preferably, the light intensities S11, S12 and the light intensities S21, S22 can be configured such that the RSD value for the total value of the light intensity S11 and S21 and the total value of the light intensity S12 and S22 is less than 3%.

Here, The RSD value for the total values of the light intensities of a plurality of overlapping color development area pairs is a relative values of the standard deviation (SD) value of each total values of the light intensities at the individual overlapping color development area pair to the mean value of the total values of the light intensities at the plurality of overlapping color development area pairs, and can be expressed by percentage. Generally, RSD value for each individual data in a data group can be calculated by: RSD value for each individual data (%)=(SD value of the individual data/mean value of the data group)×100. Thus, considering a plurality of overlapping color development area pairs including for example, two or more overlapping color development area pairs, the smaller the RSD value for the total values of the light intensities, the smaller variation around the mean value of the light intensities for the plurality of the overlapping color development areas is indicated.

The first light intensities S11 and S12 and the second light intensities S21 and S22 respectively indicate the light intensity of the reflected interference light at the overlapping color development areas as viewed in the thickness directions. Specifically, the color development area in the first pattern layer that develops color with the light of the light intensity S11 is disposed to overlap the color development area in the second pattern layer that develops color with the light of the light intensity S21, and the color development area in the first pattern layer that develops color with the light of the light intensity S12 is disposed to overlap the color development area in the second pattern layer that develops color with the light of g the light intensity S22. In the present specification, S11 and S12 indicating the first light intensities, and S21 and S22 indicating the second light intensities are intended to merely indicate the overlapping relationship of the corresponding color development areas of the first pattern layer and second pattern layer, but not intended to limit the arrangement position of the color development areas on the pattern layers. For example, each of the color development areas developing color with the reflected interference light of the first light intensities S11 and S12 can be disposed at any position on the first pattern layer, and each of the color development areas developing color with the reflected interference light of the second light intensities S21 and S22 can be disposed at any position on the second pattern layer so long they are disposed to overlap the corresponding one of the color development areas on the first pattern layer that develop color with the reflected interference light of the first light intensities S11 and S12.

The present disclosure is not limited to the number of overlapping color development area pairs configured such that the light intensities of the reflected interference light satisfy the above condition (1) or the condition (2). Among the plurality of color development area pairs included in the first pattern layer and the second pattern layer, a portion of overlapping area pairs may be configured to satisfy the condition (1) or the condition (2), or all the overlapping area pairs may be configured to satisfy the condition (1) or the condition (2).

Specifically, for example, in the configuration example of the decorative sheet 200a in which three overlapping color development areas are included in the first pattern layer 25A and the second pattern layer 25B shown in FIG. 5, the light intensities of the reflected interference light between any two color development area pairs, for example, the area pair 25a1, 25b1 and the area pair 25a2, 25b2 among the overlapping color development area pairs 25a1 and 25a2, 25b1 and 25b2, and 25c1 and 25c2, can satisfy the above condition (1) or condition (2). In this case, for example, when the condition (1) is satisfied, for example, the first pattern layer 25A and the second pattern layer 25B can be configured to, but are not limited to, satisfy S1a>S1b and S2a<S2b, for example. Further, when the condition (2) is satisfied, for example, the first pattern layer 25A and the second pattern layer 25B can be configured such that, RSD value for the total value of the light intensity S1a, S2a and the total value of the light intensity S1b, S2b is less than 10%, and preferably less than 3%.

A part of the overlapping color development area pairs 25a1 and 25a2, 25b1 and 25b2, and 25c1 and 25c2, of the decorative sheet 200a shown in FIG. 5, for example, any two color development area pairs, such as the area pair 25a1 and 25b1 and the area pair 25a2 and 25b2, the area pair 25a1 and 25c1 and the area pair 25a2 and 25c2, can be configured such that the light intensities of the reflected interference light satisfy the above condition (1) or condition (2). In this case, for example, when the condition (1) is satisfied, for example, the first pattern layer 25A and the second pattern layer 25B can be configured to, but are not limited to, satisfy S1a>S1b and S2a<S2b, and S1a>S1c and S2a<S2c, for example. Further, when the condition (2) is satisfied, for example, the first pattern layer 25A and the second pattern layer 25B can be configured such that, RSD value for the total value of the light intensity S1a, S2a and the total value of the light intensity S1b, S2b is less than 10%, and preferably less than 3%, and further, RSD value for the total value of the light intensity S1a, S2a and the total value of the light intensity S1c, S2c is less than 10%, and preferably less than 3%.

Further, all of the overlapping color development area pairs 25a1 and 25a2, 25b1 and 25b2, and 25c1 and 25c2 of the decorative sheet 200a illustrated in FIG. 5 can be configured such that the light intensities of the reflected interference light satisfy the above condition (1) or condition (2). In this case, for example, when the condition (1) is satisfied, for example, the first pattern layer 25A and the second pattern layer 25B can be configured to, but are not limited to, satisfy S1a>S1b>S1c and S2a<S2b<S2c. Further, when the condition (2) is satisfied, for example, the first pattern layer 25A and the second pattern layer 25B can be configured such that RSD value for the total value of the light intensity S1a, S2a, the total value of the light intensity S1b, S2b, and the total value of the light intensity S1c, S2c is less than 10%, and preferably less than 3%.

The disposition of the overlapping color development area pairs configured to satisfy the above condition (1) or condition (2) is not limited to the configuration example shown in FIG. 5. The overlapping color development area pairs configured to satisfy the condition (1) or the condition (2) can be disposed at any position on the first pattern layer 25A and the second pattern layer 25B.

Since the first pattern layer 25A and the second pattern layer 25B of the decorative sheet 200a include the overlapping color development area pairs configured to satisfy the above condition (1), when the incident light 35 incident from the back surface side Fb sequentially passes through the second pattern layer 25B and the first pattern layer 25A, nonuniformity of the light intensity of the transmitted lights 31aT, 31bT, and 31cT in the wavelength region λ1 output from different color development areas is reduced, and the uniformity of the luminance of the output transmitted lights 35a, 35b, and 35c can be improved.

Further, since the first pattern layer 25A and the second pattern layer 25B of the decorative sheet 200a include the overlapped color development areas configured to satisfy the above condition (2), when the incident light 35 incident from the back surface side Fb sequentially passes through the second pattern layer 25B and the first pattern layer 25A, variation in the light intensity of the transmitted lights 31aT, 31bT, and 31cT in the wavelength region λ1 output from different color development areas is suppressed, and the uniformity of the luminance of the output transmitted lights 35a, 35b, and 35c can be further improved.

The color development areas satisfying the above condition (1) or condition (2) may be configured, for example, by adjusting the content of the interference pigment particles contained in the overlapped color development areas, for example, the wt % of the interference pigment, or may be configured by adjusting the type of the interference pigment particles contained in the overlapped color development areas.

### Transmission Property of First Configuration Example of Decorative Sheet

In the decorative sheet 200a of the first configuration example of the display device 100A according to the first embodiment of the present disclosure shown in FIG. 5, the incident light 35 from the optical device 30 includes the incident light 31 in the wavelength region λ1 and the incident light 32 in the wavelength region λ2 different from the wavelength region λ1. The incident light 35 is incident to the second pattern layer 25B on the back surface of the decorative sheet 200a with substantially uniform luminance. Within the incident light 35, the incident light 31 in the wavelength region λ1 satisfies the interference condition on which the light is mutually intensified, and a part of which is reflected as reflected interference lights S2a, S2b, and S2c at the second areas 25a2, 25b2, and 25c2 of the second pattern layer 25B. The other part of the incident light 35 transmit through the second pattern layer 25B and advance in the decorative sheet 200a, and further, a part of which is reflected as the reflected interference lights S1a, S1b, and S1c at the first areas 25a1, 25b1, and 25c1 on the first pattern layer 25A. Then, light transmitted through the decorative sheet 200a is output. On the other hand, within the incident light 35, the incident light 32 in the wavelength region λ2 does not satisfy the interference condition, and transmit through the decorative sheet 200a with substantially uniform light intensity.

The lights 35a, 35b, and 35c respectively transmitted through the overlapping second area on the second pattern layer 25B and the first area on the first pattern layer 25A includes transmitted lights 31aT, 31bT, and 31cT in the wavelength region λ1 and transmitted light 32T in the wavelength region λ2 with substantially uniform light intensity. Since the first pattern layer 25A and the second pattern layer 25B include the overlapping color development area pairs configured to satisfy the condition (1), the nonuniformity of the light intensity in the wavelength region λ1 generated in the transmitted light at different areas on the second pattern layer is at least partially reduced when the light transmit through the corresponding overlapping area on the first pattern layer, thus the uniformity of the luminance of the output transmitted lights 35a, 35b, 35c is enhanced.

Further, since the first pattern layer 25A and the second pattern layer 25B include the overlapping color development area pairs configured to satisfy the above condition (2), variation in the light intensity of the transmitted light in the wavelength region λ1 is suppressed, and the uniformity of the luminance of the output transmitted lights 35a, 35b, and 35c can be further enhanced.

According to the decorative sheet 200a of the display device 100A of the first embodiment, as described above, the uniformity of the luminance of output transmitted light is enhanced, and the visibility of displaying with the transmitted light can be improved.

### Second Configuration Example of Decorative Sheet and its Transmission Property

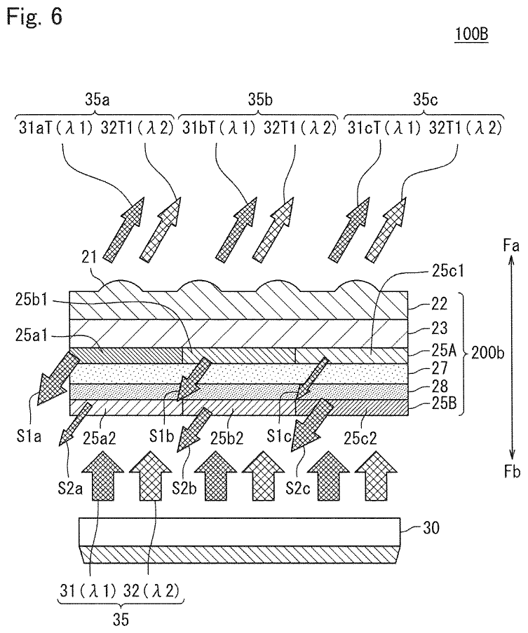

FIG. 6 is a conceptual sectional view of a display device 100B according to the first embodiment of the present disclosure, illustrating a decorative sheet 200b included and transmission properties thereof in a second configuration example. The display device 100B illustrated in FIG. 6 includes the decorative sheet 200b and the optical device 30 emitting light, which is disposed on a back surface side Fb of the decorative sheet 200b. The display device 100B is different from the display device 100A of FIG. 5 in that the decorative sheet 200b further includes a chromaticity compensation layer 28. Hereinafter, the display device 100B will be described focusing on the configurations different from the display device 100A. In FIG. 6, substantially the same components as those of the display device 100A in FIG. 5 are denoted by the same reference numerals, and associated detailed description will be omitted.

In the present embodiment, the chromaticity compensation layer 28 is disposed on the back surface side of the light shielding layer 27. In FIG. 6, the chromaticity compensation layer 28 is shown to be disposed between the light shielding layer 27 and the second pattern layer 25B, but the present disclosure is not limited to this configuration. The chromaticity compensation layer 28 may be disposed on the back surface side of the light shielding layer 27, and for example, it may be disposed on the back surface side of the second pattern layer 25B.

The chromaticity compensation layer 28 is configured to have a lower transmittance for light in a wavelength region different from the wavelength region λ1 of the reflected interference light of the first pattern layer 25A and the second pattern layer 25B in the visible incident light included in the incident light 35 decorative sheet The chromaticity compensation layer 28 can be formed as, but not limited to, an ink layer or a film layer, and can be uniformly formed as a whole. The chromaticity compensation layer 28 may include a plurality of layers.

In the lights 35a, 35b, and 35c transmitted through the decorative sheet 200a illustrated in FIG. 5, transmitted lights 31aT, 31bT, and 31cT in the wavelength region λ1 have lower light intensity than transmitted light 32T in the wavelength region λ2. Thus, in the transmitted lights 35a, 35b, and 35c on the front surface side Fa, the spectral component of the light in wavelength region λ1 is attenuated, and the chromaticity shifts occurs. In the decorative sheet 200b illustrated in FIG. 6, since the chromaticity compensation layer 28 having a low transmittance for the visible incident light 32 in the wavelength region λ2 different from the wavelength region λ1 within the lights 35a, 35b, and 35c, the light in the wavelength region λ2 is attenuated by the chromaticity compensation layer 28 while transmitting through the decorative sheet 200b, and is output as transmitted light 32T1. This can reduce the chromaticity shifts caused by the attenuation of the spectral component of the light in the wavelength region λ1. In addition, by adjusting the transmittance of the chromaticity compensation layer 28, the chromaticity shifts occur when light is transmitted through the first pattern layer 25A and the second pattern layer 25B can be substantially cancelled. This allows the lights 35a, 35b, and 35c transmitted through the decorative sheet 200a to be output with a spectrum substantially similar to that of the incident light 35 from the optical device 30.

According to the decorative sheet 200b of the display device 100B of the first embodiment, as described above, the uniformity of the luminance of transmitted light is enhanced, the chromaticity shifts occur in transmitted light can be reduced, thus the visibility of displaying with the transmitted light can be improved.

### Third Configuration Example of Decorative Sheet and its Transmission Property

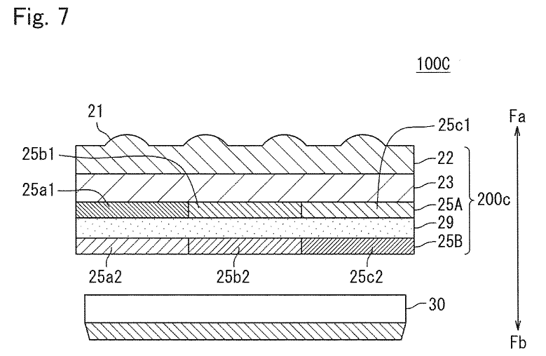

FIG. 7 is a conceptual sectional view of a display device 100C according to the first embodiment of the present disclosure, illustrating a decorative sheet 200c in a third configuration example. The display device 100C illustrated in FIG. 7 includes the decorative sheet 200c and the optical device 30 emitting light, which is disposed on the back surface side Fb of the decorative sheet 200c. The display device 100C is different from the display device 100A of FIG. 5 in that the decorative sheet 200c further includes a chromaticity compensation light shielding layer 29. Hereinafter, the display device 100C will be described focusing on the configurations different from the display device 100A. In FIG. 7, substantially the same components as those of the display device 100A in FIG. 5 are denoted by the same reference numerals, and associated detailed description will be omitted.

The chromaticity compensation light shielding layer 29 of the decorative sheet 200c is a layer in which the light shielding layer 27 of the decorative sheet 200a in FIG. 5 and the chromaticity compensation layer 28 of the decorative sheet 200b in FIG. 6 are integrally formed, and similarly to the light shielding layer 27, the layer is configured to have a transmittance of less than 50% for light in the visible region incident on the decorative sheet 200c, and can be used to conceal components disposed on the back surface side of the decorative sheet 200c such that the components are not visually recognized from the front surface side Fa. Similar to the chromaticity compensation layer 28, the chromaticity compensation light shielding layer 29 is configured to attenuate the light intensity of transmitted visible light in a wavelength region different from the wavelength region λ1, and can reduce the chromaticity shifts generated when the light is transmitted through the first pattern layer 25A and the second pattern layer 25B. By integrally forming the light shielding layer and the chromaticity compensation layer 28, a decorative sheet can be made compact.

According to the decorative sheet 200c of the display device 100C of the first embodiment, as described above, the uniformity of the luminance of transmitted light is enhanced, the chromaticity shifts occur in transmitted light can be reduced, thus the visibility of displaying with the transmitted light can be improved.

### Fourth Configuration Example of Decorative Sheet and its Transmission Property

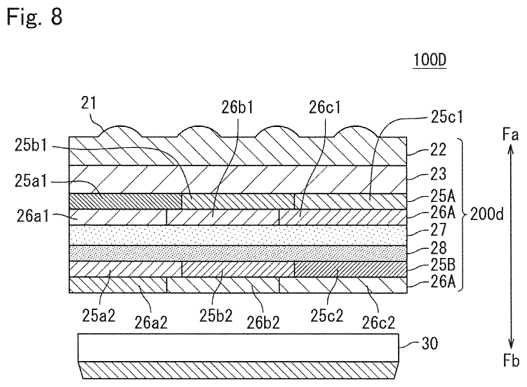

FIG. 8 is a conceptual sectional view of a display device 100D according to the first embodiment of the present disclosure, illustrating a decorative sheet 200d in a fourth configuration example. The display device 100D illustrated in FIG. 8 includes the decorative sheet 200d and the optical device 30 emitting light, which is disposed on the back surface side Fb of the decorative sheet 200d. The display device 100D is different from the display device 100B in FIG. 6 in that the decorative sheet 200d includes a plurality of first pattern layers 25A, 26A and a plurality of second pattern layers 25B, 26B. Hereinafter, the display device 100D will be described focusing on the configurations different from the display device 100B. In FIG. 8, substantially the same components as those of the display device 100B in FIG. 6 are denoted by the same reference numerals, and associated detailed description thereof will be omitted.

The decorative sheet 200d in FIG. 8 includes the hard coat layer 22, the base layer 23, first pattern layers 25A and 26A, the light shielding layer 27, the chromaticity compensation layer 28, and second pattern layer 25B and 26B in the thickness direction from the front surface side Fa to the back surface side Fb.

The first pattern layer 25A includes the first areas 25a1, 25b1, and 25c1 that are a plurality of color development areas, and the first areas 25a1, 25b1, and 25c1 are configured to contain interference pigments that develop color with reflected interference lights of different light intensities but substantially in the same wavelength region λ11. The first pattern layer 26A includes first areas 26a1, 26b1, and 26c1 that are a plurality of color development areas, and the first areas 26a1, 26b1, and 26c1 are configured to contain interference pigments that develop color with reflected interference lights of different light intensities but substantially in the same wavelength region λ12.

The second pattern layer 25B is configured to correspond to the first pattern layer 25A, and is configured to contain an interference pigment that reflects light incident and develops color with reflected interference light substantially in the same wavelength region λ11 as that for the first pattern layer 25A. The second pattern layer 25B includes the second areas 25a2, 25b2, and 25c2 that are a plurality of color development areas, and each of the second areas 25a2, 25b2, and 25c2 is disposed to overlap the corresponding one of the first areas 25a1, 25b1, and 25c1 on the first pattern layer 25A when viewed from the thickness directions of the decorative sheet.

The second pattern layer 26B is configured to correspond to the first pattern layer 26A, and is configured to contain an interference pigment that reflects light incident and develops color with reflected interference light substantially in the same wavelength region λ12 as that for the first pattern layer 26A. The second pattern layer 26B includes second areas 26a2, 26b2, and 26c2 that are a plurality of color development areas, and each of the second areas 26a2, 26b2, and 26c2 is disposed to overlap the corresponding one of the first areas 26a1, 26b1, and 26c1 on the first pattern layer 26A when viewed from the thickness directions of the decorative sheet.

The decorative sheet 200d in FIG. 8 is shown to include two layers of the first pattern layers and two layers of the second pattern layers, but the present disclosure is not limited to this configuration. The decorative sheet can include any number of first pattern layers and second pattern layers. The plurality of layers of the first pattern layers and the second pattern layers can be produced by lamination printing with a printing method such as screen printing or gravure printing.

The present disclosure is not limited to the configuration of the plurality of color development areas or the number of areas of each first pattern layer and second pattern layer. These color development areas may be configured, for example, by adjusting the content of the interference pigment particles, for example, the wt % of the interference pigment, or may be configured by including different types of interference pigment particles. Each first pattern layer and second pattern layer may be configured to include any number of two or more color development areas, and each color development area can have any shape and/or dimension. The color development areas in the same pattern layer can be freely defined but not overlapping with each other, different first pattern layer and different second pattern layer can include color development areas with different shapes and/or dimensions, and each pattern layer can be configured with any thickness according to intended uses.

In the decorative sheet 200d, the corresponding first pattern layer 25A and second pattern layer 25B can include color development areas configured to satisfy the condition (1) or the condition (2) to improve the uniformity of the luminance of the light in the wavelength region λ11 respectively transmitted through the overlapping first areas 25a1, 25b1, and 25c1 and the second areas 25a2, 25b2, and 25c2. Similarly, for the first pattern layer 25A and the second pattern layer 25B, the corresponding first pattern layer 26A and second pattern layer 26B also include color development areas configured to satisfy the condition (1) or the condition (2), and thus the uniformity of the luminance of the light in the wavelength region λ12 respectively transmitted through the overlapping first areas 26a1, 26b1, and 26c1 and the second areas 26a2, 26b2, and 26c2 can be improved.

The decorative sheet 200d includes the chromaticity compensation layer 28, and thus the light intensity of transmitted visible light in a wavelength region different from the wavelength regions λ11 and λ12 can be attenuated. Thus, the chromaticity shifts occur when the light is transmitted through the first pattern layers 25A and 26A and the second pattern layers 25B and 26B can be reduced.

According to the decorative sheet 200d of the display device 100D of the first embodiment, as described above, the uniformity of the luminance of transmitted light is enhanced, the chromaticity shifts occur in transmitted light can be reduced, and thus the visibility of displaying with the transmitted light can be improved.

### Second Embodiment

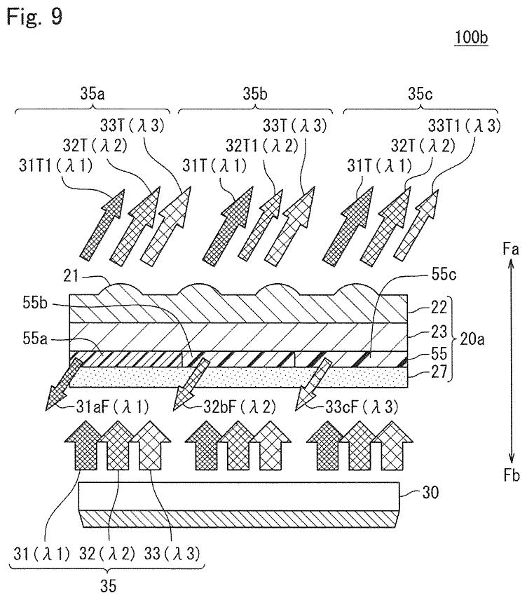

The pattern layer 25 of the decorative sheet 20a of the display device 100a shown in FIG. 4 is configured to include the areas 25a, 25b, and 25c developing color with reflected interference lights of different light intensities but substantially in the same wavelength region λ1. However, the present disclosure is not limited to this configuration. The pattern layer of the decorative sheet can also be configured to include areas developing color with reflected interference light in different wavelength regions. At this case, the visibility of displaying of the display device may be affected by the transmission properties of the interference pigment. This will be described below with reference to FIG. 9. FIG. 9 is a conceptual sectional view for describing the influence of the transmission properties of the interference pigment.

FIG. 9 illustrates a display device 100b including the optical device 30 and a decorative sheet 20b. The decorative thin material 20b includes a pattern layer 55 containing an interference pigment. The decorative sheet 20b is different from the decorative sheet 20a illustrated in FIG. 4 in the configuration of the pattern layer 55. Hereinafter, the display device 100b will be described focusing on the configurations different from the display device 100a. In FIG. 9, substantially the same components as those of the display device 100a in FIG. 4 are denoted by the same reference numerals, and associated detailed description thereof will be omitted.

The pattern layer 55 of the decorative sheet 20b is configured to include interference pigments that develop color with reflected interference light in different wavelength regions. As illustrated in the figure, the pattern layer 55 includes areas 55a, 55b, and 55c, and the areas 55a, 55b, and 55c are configured to include interference pigments that develop color with reflected interference lights in the different wavelength regions λ1, λ2, and λ3. The areas developing color with the reflected interference lights in different wavelength regions may be configured by, for example, adjusting the thickness of the shell portion of the interference pigment particles to be contained, or may be configured by containing different types of interference pigment particles.

The optical device 30 inputs light 35 to the decorative sheet 20b from the back surface side Fb. The incident light 35 includes incident lights 31, 32, and 33 in the different wavelength regions λ1, λ2, and λ3, and is incident on the back surface of the decorative sheet 20a with substantially uniform luminance. Within the incident light 35, the incident light 31 in the wavelength region λ1 satisfies the interference condition on which the light is mutually intensified in the area 55a of the pattern layer 55, and the reflected interference light 31aF in the wavelength region λ1 is reflected at the area 35a. Similarly, within the incident light 35, the incident light 32 in the wavelength region λ2 and the incident light 33 in the wavelength region 23 satisfy the interference condition on which the light is mutually intensified at the area 55b and the area 55c of the pattern layer 35, respectively, and the reflected interference light 32aF in the wavelength region λ2 and the reflected interference light 33aF in the wavelength region λ3 are reflected at the area 55b and the area 55c, respectively.

On the front surface side Fa, transmitted lights 35a, 35b, and 35c including lights having complementary colors with the reflected interference lights 31aF, 31bF, and 31cF are output from the areas 55a, 55b, and 55c, respectively. In the transmitted light 35a, the transmitted light 31T1 in the wavelength region λ1 has a lower light intensity than the transmitted lights 32T and 33T in the wavelength regions λ2 and λ3 that do not satisfy the interference condition, and the spectral component of the light in the wavelength region λ1 is attenuated. Similarly, in each of the transmitted lights 35b and 35c, the spectral component of the light in the wavelength region λ2 or λ3 is attenuated. In this manner, when the incident light is transmitted through the decorative sheet 20b, the spectral components of the light in different wavelength regions are attenuated in different color development areas. As a result, on the surface of the decorative sheet 20b, un-uniformity occurs in the spectrum of the transmitted light output from different color development areas, and thus the visibility of displaying is impaired.

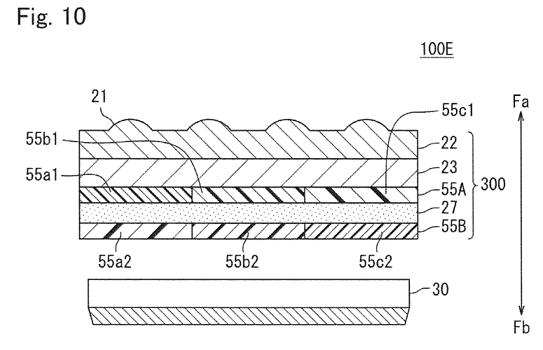

The decorative sheet according to a second embodiment of the present disclosure aims to solve the above problem in the decorative sheet 20b and improve the visibility of displaying with transmitted light. Hereinafter, the configuration of the decorative sheet according to the second embodiment will be described with reference to FIGS. 10 to 12. In FIGS. 10 to 12, substantially the same components are denoted by the same reference numerals, and associated detailed description thereof will be omitted.

### Configuration of Display Device and Decorative Sheet

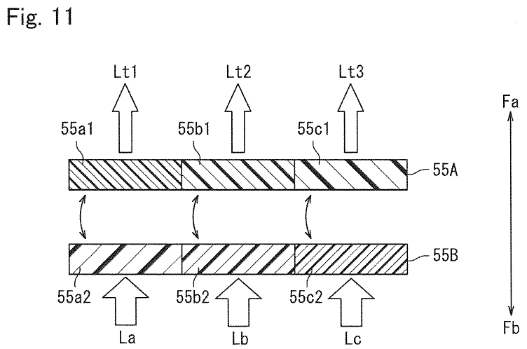

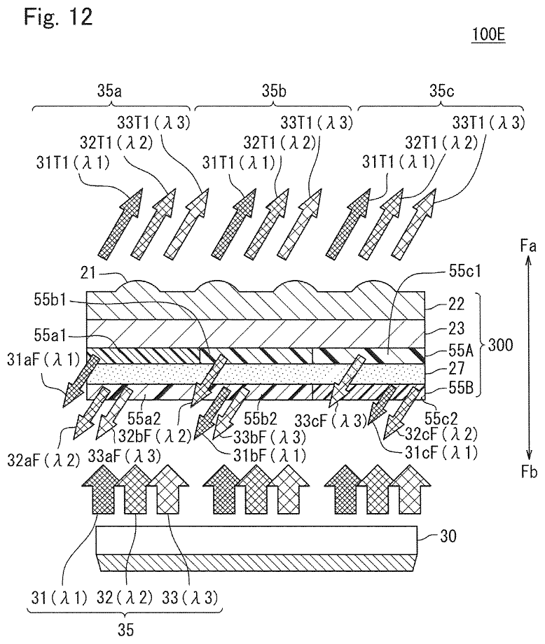

FIG. 10 is a conceptual sectional view illustrating a display device 100E according to the second embodiment of the present disclosure. FIG. 11 is a conceptual sectional view illustrating a configuration of a pattern layer of a decorative sheet 300 according to the second embodiment. FIG. 12 is a conceptual sectional view of the display device 100E according to the second embodiment, illustrating the decorative sheet 300 included and the transmission properties thereof.

The display device 100E of the second embodiment illustrated in FIG. 10 includes the decorative sheet 300 and the optical device 30 emitting light, which is disposed on the back surface side Fb of the decorative sheet 300. The decorative sheet 300 includes the hard coat layer 22, the base layer 23, the first pattern layer 55A, the light shielding layer 27, and the second pattern layer 55B in the thickness direction from the front surface side Fa to the back surface side Fb. The decorative sheet 300 may be produced by stacking each constituent layer with an adhesive layer having light transparency interposed therebetween, or may be produced through lamination printing of each constituent layer with a printing method such as screen printing or gravure printing.

The display device 100E is different from the display device 100A of FIG. 5 in the configuration of the first pattern layer 55A and the second pattern layer 55B of the decorative sheet 300. Hereinafter, the display device 100E will be described focusing on the configurations different from the display device 100A. In FIG. 10, substantially the same components as those of the display device 100A in FIG. 5 are denoted by the same reference numerals, and associated detailed description thereof will be omitted.

As illustrated in FIG. 11, the first pattern layer 55A of the decorative sheet 300 is configured to include the first areas 55a1, 55b1, and 55c1, which are a plurality of color development areas containing interference pigments that develop color with reflected interference light in the different wavelength regions λ1, λ2, and λ3.

The second pattern layer 35B includes the second areas 55a2, 55b2, and 55c2, which are a plurality of color development areas, and each of the second areas 55a2, 55b2, and 55c2 is disposed to overlap the corresponding one of the first areas 35a1, 35b1, and 35c1 on the first pattern layer 35A when viewed from the thickness directions (directions indicated by the arrows in the figure) of the decorative sheet. Thus, when the optical device 30 is turned on, a part of the incident light 35 incident from the back surface side Fb can be transmitted through the overlapping second area on the second pattern layer 35B and first area on the first pattern layer 35A, and output at the front surface side Fa.

In the present embodiment, the overlapping area pairs on the first pattern layer 55A and the second pattern layer 55B, for example, as shown in the figure, at least a part of the first area 55a1 and the second area 55a2, the first area 55b1 and the second area 55b2, and the first area 55c1 and the second area 55c2 can be configured to contain interference pigments that develop colors having complementary colors with each other. That is, at least a part of the overlapping first area and the second area contains interference pigments that develop a pair of colors at diametrical positions opposite to each other in the color wheel. In generally, complementary colors with each other include color pairs having the largest hue difference therebetween such as, for example, the color pair of red and blue-green, or the color pair of yellow and blue-purple.

The combination of the reflected interference lights of the interference pigment particles that develop complementary colors results to a spectrum of substantially white light. Thus, as shown in FIG. 11, when the incident light Lb is transmitted through the overlapping second area on the second pattern layer 55B and first area the first pattern layer 35A that are configured to develop complementary colors, the spectral component of the light in each wavelength region is substantially uniformly attenuated, and the transmitted lights Lt1, Lt2, and Lt3 can be output with a substantially uniform spectrum.

The present disclosure is not limited to the configuration of the plurality of color development areas or the number of areas of the first pattern layer 55A and the second pattern layer 55B. These color development areas may be configured, for example, by adjusting the content of the interference pigment particles, for example, the wt % of the interference pigment, or may be configured by including different types of interference pigment particles. The first pattern layer 55A and the second pattern layer 55B may be configured to include any number of two or more color development areas, and each color development area can have any shape and/or dimension. The color development areas in the same pattern layer can be freely defined but not overlapping with each other, and each pattern layer can be configured with any thickness according to intended uses. Further, the first pattern layer 55A and the second pattern layer 55B can be configured such that incident light from the back surface side Fb is transmitted through the respective overlapping second areas and first areas and is output with substantially uniform luminance by adjusting the content of the interference pigment particles or the type of the interference pigment particles contained.

### Transmission Property of Decorative Sheet

As illustrated in FIG. 12, the optical device 30 inputs light 35 to the decorative sheet 300 from the back surface side Fb. The incident light 35 includes incident lights 31, 32, and 33 in the different wavelength regions λ1, λ2, and λ3, and is incident on the back surface of the decorative sheet 300 with substantially uniform luminance.

The first area 55a1 of the first pattern layer 55A includes the interference pigment that reflects light incident and develops color with the reflected interference light in the wavelength region λ1. In the first area 55a, the incident light in the wavelength region λ1 satisfies the interference condition on which the light is mutually intensified, and is reflected as reflected interference light. In the second area 35a2 including the interference pigment that reflects light incident and develops complementary color with that of the first area 35a1, light in the wavelength regions λ2 and λ3 different from the wavelength region λ1 satisfied the interference condition, and is reflected as reflected interference light. As a result, the light 35a transmitted through the overlapping second area 35a2 and first area 35a1 is output including transmitted light components 31T1, 32T1, and 33T1, which are substantially uniformly attenuated from the incident light 31, 32, and 33 in each wavelength region λ1, λ2, and λ3. Similarly, the lights 35b and 35c transmitted through the overlapped second areas 35b2, 35c2 and first areas 35b1, 35c1 can be output including transmitted light components 31T1, 32T1, and 33T1, which are substantially uniformly attenuated from the incident lights 31, 32, and 33 in each wavelength region λ1, λ2, and λ3. Thus, when the incident light is transmitted through the decorative sheet 300, by passing the overlapping color development areas configured to develop complementary colors, the light component in each wavelength region is substantially uniformly attenuated, thus the uniformity of the spectrum of the transmitted light output from the surface of the decorative sheet 300 is enhanced, and the visibility of displaying can be improved.

According to the decorative sheet 300 of the display device 100E of the second embodiment, as described above, the uniformity of the spectrum of transmitted light is enhanced, and the visibility of displaying with the transmitted light can be improved.

As described above, the above-described embodiments have been described as examples of the technique in the present disclosure. The drawings and the detailed description are provided for this purpose. Thus, the components described in the drawings and the detailed description may include not only components essential for solving the problem but also components that are not essential for solving the problem in order to illustrate the above-described technique. Thus, it should not be immediately recognized that these non-essential components are essential just from the fact that these non-essential components are described in the drawings and the detailed description.

In addition, since the above-described embodiments are intended to illustrate the technique in the present disclosure, various changes, replacements, additions, omissions, and the like can be made within the scope of the claims or equivalents thereof.

The present disclosure is applicable to a decorative sheet and a display device including the decorative sheet. The present disclosure is widely applicable in the fields including in-vehicle components, home electric appliances, and household equipment.
11, 12, 13 light displaying
20, 20a, 20b decorative sheet
21 textured pattern
22 hard coat layer
23 base layer
25 pattern layer
25A, 25B, 26A, 26B pattern layer
55, 55A, 55B pattern layer
27 light shielding layer
28 chromaticity compensation layer
29 chromaticity compensation light shielding layer
30 optical device
50 external light source
100, 100a, 100b display device
100A, 100B, 100C, 100D, 100E display device
200a, 200b, 200c, 200d, 300 decorative sheet
210 interference pigment particle
211 core portion
212 shell portion

What is claimed is:

1. A decorative sheet including a number of layers between a front surface and a back surface, the decorative sheet comprising:
a first pattern layer including an interference pigment that reflects light incident and develops color with reflected interference light in a first wavelength region, the first pattern layer including a first area that develops color with the reflected interference light of a first light intensity and a second area that develops color with the reflected interference light of a second light intensity;
a second pattern layer including an interference pigment that reflects light incident and develops color with reflected interference light in the first wavelength region, the second pattern layer including a third area that develops color with the reflected interference light of a third light intensity and a fourth area that develops color with the reflected interference light of a fourth light intensity,
wherein in a thickness direction of the decorative sheet, the first region and the third region are disposed to overlap each other, and the second region and the fourth region are disposed to overlap each other,
the first light intensity is greater than the second light intensity, and the third light intensity is less than the fourth light intensity.

2. The decorative sheet according to claim 1, wherein a relative standard deviation value for a total value of the first light intensity and the third light intensity, and a total value of the second light intensity and the fourth light intensity is less than 10%.

3. The decorative sheet according to claim 1, further comprising a light shielding layer disposed between the first pattern layer and the second pattern layer,
wherein the light shielding layer has a transmittance of less than 50% for incident light in a visible region.

4. The decorative sheet according to claim 3, further comprising a chromaticity compensation layer disposed between the light shielding layer and the back surface of the decorative sheet,
wherein the chromaticity compensation layer has a lower transmittance for light in a wavelength region different from the first wavelength region than that for light in the first wavelength region.

5. The decorative sheet according to claim 4, wherein the light shielding layer and the chromaticity compensation layer are integrally formed.

6. The decorative sheet according to claim 1, wherein
the first pattern layer includes two or more layers each including an interference pigment that reflects light incident and develops color with reflected interference light in a wavelength region different from each other,
the second pattern layer includes two or more layers each corresponding to one of the plurality of layers of the first pattern layer, the two or more layers of the second pattern layer each including an interference pigment that reflects light incident and develops color with reflected interference light in a substantially same wavelength region as the wavelength region of the reflected interference light with which the interference pigment of a corresponding one of the two or more layers of the first pattern layers develops color, and
each layer of the two or more layers of the second pattern layer includes areas disposed to overlap each of the areas included in the corresponding one of the two or more layers of the first pattern layer as viewed in the thickness direction.

7. A display device comprising:
the decorative sheet according to claim 1; and
an optical device that emits light, the optical device being disposed to face the back surface of the decorative sheet.

8. A decorative sheet including a number of layers between a front surface and a back surface, the decorative sheet comprising:
a first pattern layer including an interference pigment that reflects light incident and develops color with reflected interference light, the first pattern layer including two or more first areas that each develop color with the reflected interference light a wavelength region different from each other;
a second pattern layer including an interference pigment that reflects light incident and develops color with reflected interference light, the second pattern layer including two or more second areas that are disposed to overlap each of the first areas in a thickness direction of the decorative sheet,
wherein at least a part of the first areas and the second areas overlapping each other include interference pigments that develop complementary colors with each other.

9. The decorative sheet according to claim 8, further comprising a light shielding layer disposed between the first pattern layer and the second pattern layer,
wherein the light shielding layer has a transmittance of less than 50% for incident light in a visible region.

10. A display device comprising:
the decorative sheet according to claim 8; and
an optical device that emits light, the optical device being disposed to face the back surface of the decorative sheet.

11. The decorative sheet according to claim 2, further comprising a light shielding layer disposed between the first pattern layer and the second pattern layer,
wherein the light shielding layer has a transmittance of less than 50% for incident light in a visible region.

12. The decorative sheet according to claim 2, wherein
the first pattern layer includes two or more layers each including an interference pigment that reflects light incident and develops color with reflected interference light in a wavelength region different from each other,
the second pattern layer includes two or more layers each corresponding to one of the plurality of layers of the first pattern layer, the two or more layers of the second pattern layer each including an interference pigment that reflects light incident and develops color with reflected interference light in a substantially same wavelength region as the wavelength region of the reflected interference light with which the interference pigment of a corresponding one of the two or more layers of the first pattern layers develops color, and
each layer of the two or more layers of the second pattern layer includes areas disposed to overlap each of the areas included in the corresponding one of the two or more layers of the first pattern layer as viewed in the thickness direction.

13. A display device comprising:
the decorative sheet according to claim 2; and
an optical device that emits light, the optical device being disposed to face the back surface of the decorative sheet.

14. A display device comprising:
the decorative sheet according to claim 9; and
an optical device that emits light, the optical device being disposed to face the back surface of the decorative sheet.
